(19) United States
(12) Patent Application Publication
(10) Pub. No.: US 2014/0250892 A1
(43) Pub. Date: Sep. 11, 2014

(54) LEAN FUEL INTAKE GAS TURBINE

(71) Applicant: KAWASAKI JUKOGYO KABUSHIKI KAISHA, Kobe-shi, Hyogo (JP)

(72) Inventors: Soh Kurosaka, Kobe-shi (JP); Shinichi Kajita, Kobe-shi (JP); Yoshihiro Yamasaki, Kobe-shi (JP); Yasushi Doura, Kobe-shi (JP)

(73) Assignee: KAWASAKI JUKOGYO KABUSHIKI KAISHA, Kobe-shi, Hyogo (JP)

(21) Appl. No.: 14/349,392

(22) PCT Filed: Oct. 15, 2012
(86) PCT No.: PCT/JP2012/076596

§ 371 Date: Apr. 3, 2014

(30) Foreign Application Priority Data
Oct. 17, 2011 (JP) 2011-227642

(51) Int. Cl. F02C 7/22

(52) U.S. Cl. CPC F02C 7/22
USPC 60/737

(57) ABSTRACT

A lean fuel intake gas turbine which uses, as a working gas, a mixed gas having a concentration equal to or lower than a flammability limiting concentration and obtained by mixing two types of fuel gases having different fuel concentrations, includes a first mixer configured to mix a second fuel gas having a higher fuel concentration with a first fuel gas having a lower fuel concentration, of the two types of the fuel gases having different fuel concentrations, to generate a first stage mixed gas and a second mixer configured to further mix the second fuel gas with the first stage mixed gas to generate a second stage mixed gas which is the working gas.

### CROSS REFERENCE TO THE RELATED APPLICATION

This application is based on and claims Convention priority to Japanese patent application No. 2011-227642, filed Oct. 17, 2011, the entire disclosure of which is herein incorporated by reference as a part of this application.

### BACKGROUND OF THE INVENTION

1. Field of the Invention

The present invention relates to a lean fuel intake gas turbine which sucks thereinto to use, as a fuel, a combustible component contained in a mixture which is obtained by mixing a low-calorie gas, such as CMM (Coal Mine Methane) generated from a coal mine, with air etc. into a gaseous mixture having a concentration equal to or lower than a combustible limit concentration such that ignition does not occur due to compression of a compressor.

2. Description of Related Art

In an existing lean fuel intake gas turbine, VAM (Ventilation Air Methane) and CMM having respective fuel concentrations different from each other are mixed into a uniform fuel concentration by one mixer, and the mixed fuel is fed to an intake port of a compressor. In addition, in order to ensure responsiveness at the time of startup and at the time of load variation, the mixer is arranged in the vicinity of the intake port. Thus, when a control operation cannot follow variation of the CMM fuel concentration due to delay of measurement of a CMM fuel concentration meter and delay of operation of a CMM fuel control valve and thus the fuel concentration is excessively increased, an explosion may occur within the compressor, and when the fuel concentration is excessively decreased for the same reason, a flame off may occur in a catalytic combustor.

### PRIOR ART DOCUMENT

[Patent Document 1] JP Laid-open Patent Publication No. 2010-019247

### SUMMARY OF THE INVENTION

As a countermeasure therefor, hitherto, when the CMM fuel concentration exceeds a predetermined value, fuel supply is stopped to stop operation of the gas turbine. In addition, when the CMM fuel concentration becomes lower than a predetermined value, a catalytic combustion state is determined from a measured value of the temperature of a catalyst, and the fuel supply is stopped and the operation of the gas turbine is stopped if it is determined as a flame off. Therefore, when the CMM fuel concentration frequently varies, the gas turbine is frequently stopped, and accordingly stable operation is difficult.

Therefore, an object of the present invention is to provide, in order to solve the above-described problem, a lean fuel intake gas turbine which is able to avoid an explosion within a compressor and a flame off in a catalytic combustor, without stopping operation of the gas turbine, to enable stable operation even when a fuel concentration of a mixed fuel gas is varied.

In order to achieve the above-described object, a lean fuel intake gas turbine according to the present invention is a lean fuel intake gas turbine which uses, as a working gas, a mixed gas having a concentration equal to or lower than a flammability limiting concentration and obtained by mixing two types of fuel gases having different fuel concentrations, and includes: a compressor configured to compress the working gas to generate a compressed gas; a catalytic combustor configured to burn the compressed gas by a catalytic reaction; a turbine configured to be driven by a combustion gas from the catalytic combustor; a first mixer configured to mix a second fuel gas having a higher fuel concentration with a first fuel gas having a lower fuel concentration, of the two types of the fuel gases having different fuel concentrations, to generate a first stage mixed gas; and a second mixer configured to further mix the second fuel gas with the first stage mixed gas to generate a second stage mixed gas which is the working gas.

According to this configuration, it is possible to mix the second fuel gas having a higher fuel concentration separately with the two mixers at two stages, and thus concentration adjustment of the entire working gas is easily performed responding to variation of the fuel concentration of the second fuel gas. Therefore, even when the fuel concentration of the second fuel gas (e.g., CMM) is varied, it is possible to avoid an explosion within the compressor and a flame off in the catalytic combustor to enable stable operation.

In one embodiment of the present invention, the lean fuel intake gas turbine may further include a controller configured to adjust a fuel concentration of the first stage mixed gas generated by the first mixer, to a minimum concentration necessary for the gas turbine to drive a load, and to adjust a fuel concentration of the second stage mixed gas generated by the second mixer, to a concentration necessary to obtain rated output of the gas turbine. With this configuration, since the minimum fuel concentration necessary to drive the load is ensured at the first mixer, even when a flow rate of the second fuel gas flowing into the second mixer when the fuel concentration of the second fuel gas is increased is reduced, it is possible to assuredly avoid a flame off in the catalytic combustor. Therefore, further stable operation is enabled with respect to variation of the fuel concentration of the second fuel gas.

In one embodiment of the present invention, a distance of a fuel passage from the first mixer to the second mixer may be set so as to be longer than a distance reached by the first stage mixed gas moving in the fuel passage during a delay time of the concentration adjustment by the controller. In accordance to this configuration, when the fuel concentration of the second fuel gas is varied, it is possible to perform concentration adjustment control before the first stage mixed gas of the first fuel gas and the second fuel gas reaches the second mixer which generates the final working gas, and thus it is possible to more assuredly avoid an explosion within the compressor and a flame off in the catalytic combustor.

In one embodiment of the present invention, the controller may include a regulator to regulate an upper limit of a total flow rate of the second fuel gas to be mixed with the first fuel gas. With this configuration, even when the fuel concentration of the second fuel gas is rapidly increased, it is possible to assuredly avoid an explosion within the compressor.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic configuration of a lean fuel intake gas turbine according to an embodiment of the present invention;

FIG. 2 is a block diagram showing a schematic configuration of a controller of the gas turbine in FIG. 1;

FIG. 3 is a block diagram showing a schematic configuration of a lean fuel intake gas turbine according to a modification of the embodiment shown in FIG. 1; and

FIG. 4 is a block diagram showing a schematic configuration of a lean fuel intake gas turbine according to another modification of the embodiment shown in FIG. 1.

### DESCRIPTION OF EMBODIMENTS

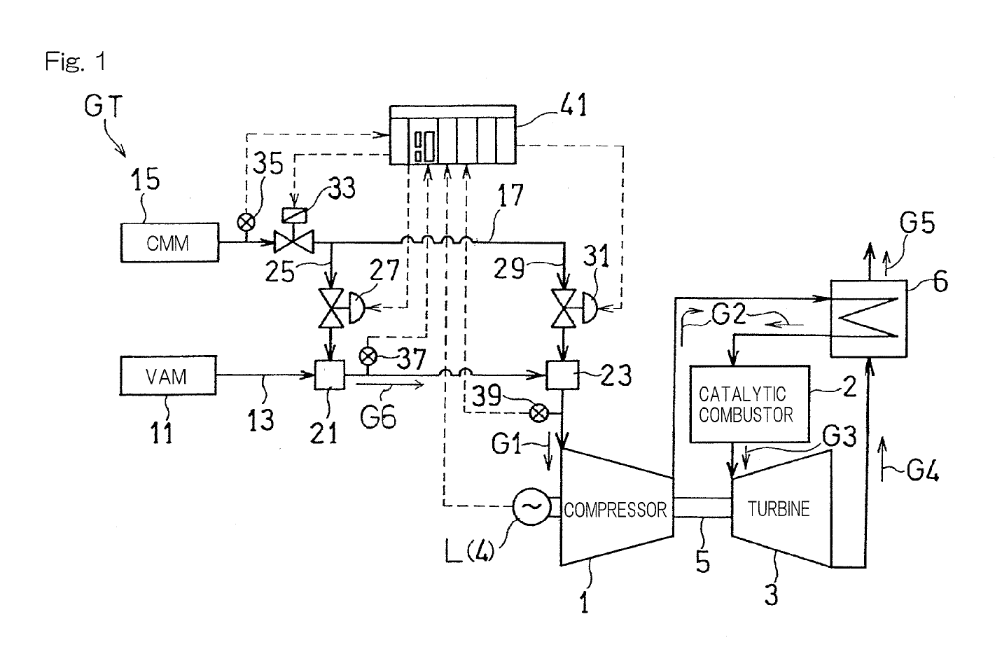

Hereinafter, embodiments of the present invention will be described with reference to the drawings. FIG. 1 is a schematic configuration diagram showing a lean fuel intake gas turbine GT according to an embodiment of the present invention. The gas turbine GT includes a compressor 1, a catalytic combustor 2 including a catalyst such as platinum, palladium, or the like, and a turbine 3. A load L such as a generator 4 is driven by output of the gas turbine GT.

As a low-calorie gas used in the gas turbine GT, a working gas G1 obtained by mixing two types of fuel gases having different fuel concentrations such as VAM generated from a coal mine and CMM having a combustible component (methane) concentration higher than that of the VAM is introduced into the gas turbine GT via an intake port of the compressor 1. A fuel gas supply system will be described in detail later. The working gas G1 is compressed by the compressor 1 into a high-pressure compressed gas G2, and the compressed gas G2 is sent to the catalytic combustor 2. The compressed gas G2 is burned by a catalytic reaction with the catalyst of the catalytic combustor 2 such as platinum, palladium, or the like, and the resulting high-temperature and high-pressure combustion gas G3 is supplied to the turbine 3 to drive the turbine 3. The turbine 3 is connected to the compressor 1 and the generator 4 via a rotation shaft 5, and the compressor 1 and the generator 4 are driven by the turbine 3.

The gas turbine GT further includes a heat exchanger 6 which heats the compressed gas G2 introduced from the compressor 1 into the catalytic combustor 2, using an exhaust gas G4 from the turbine 3. An exhaust gas G5 discharged from the heat exchanger 6 is passed through a silencer, which is not shown, to be silenced, and then is released to the outside.

The configuration of the fuel supply system for the gas turbine GT will be described in detail. The fuel supply system mixes, with a first fuel gas (VAM in this example) having a lower methane concentration (generally approximately 0.5%), an appropriate amount of a second fuel gas (CMM in this example) having a methane concentration (generally 20 to 30%) higher than that of the first fuel gas, and supplies the mixture to the compressor 1. Specifically, the fuel supply system includes a fuel main supply passage 13 which extends from a VAM supply source 11 and is connected to the compressor 1; and a fuel auxiliary supply passage 17 which extends from a CMM supply source 15 and communicates with the main supply passage 13 via various valves described later. Mixing of the CMM from the fuel auxiliary supply passage 17 to the fuel main supply passage 13 is performed by two mixers, namely, a first mixer 21 provided at the upstream side on the fuel main supply passage 13 and a second mixer 23 provided at the downstream side of the first mixer 21 and in the vicinity of the intake port of the compressor 1 on the fuel main supply passage 13. In other words, the first mixer 21 mixes the CMM having a higher fuel concentration with the VAM having a lower fuel concentration, of the two types of the fuel gases having different fuel concentrations, to generate a first stage mixed gas G6, and the second mixer 23 further mixes the CMM with the first stage mixed gas to generate a second stage mixed gas which is the working gas G1.

A first fuel control valve 27 which adjusts a flow rate of the CMM fuel is provided on a first connection passage 25 which allows the fuel auxiliary supply passage 17 to communicate with the first mixer 21, and a second fuel control valve 31 which similarly adjusts a flow rate of the CMM fuel is provided on a second connection passage 29 which allows the fuel auxiliary supply passage 17 to communicate with the second mixer 23. Furthermore, a fuel cut-off valve 33 which cuts off flow of the CMM fuel is provided at the upstream side of a branch point on the fuel auxiliary supply passage 17 to the first connection passage 25. In addition, the first to third methane concentration meters 35, 37, and 39 which measure a methane concentration are provided at respective downstream sides of the CMM supply source 15, the first mixer 21, and the second mixer 23, respectively.

Each of concentration values detected by the first to third methane concentration meters 35, 37, and 39 is transmitted to a controller 41. In addition, a power output value of the generator 4 is also transmitted to the controller 41. The controller 41 regulates the fuel cut-off valve 33, the first fuel control valve 27, and the second fuel control valve 31 on the basis of these inputted values, thereby controlling the concentration of the fuel to be supplied to the intake port of the compressor 1.

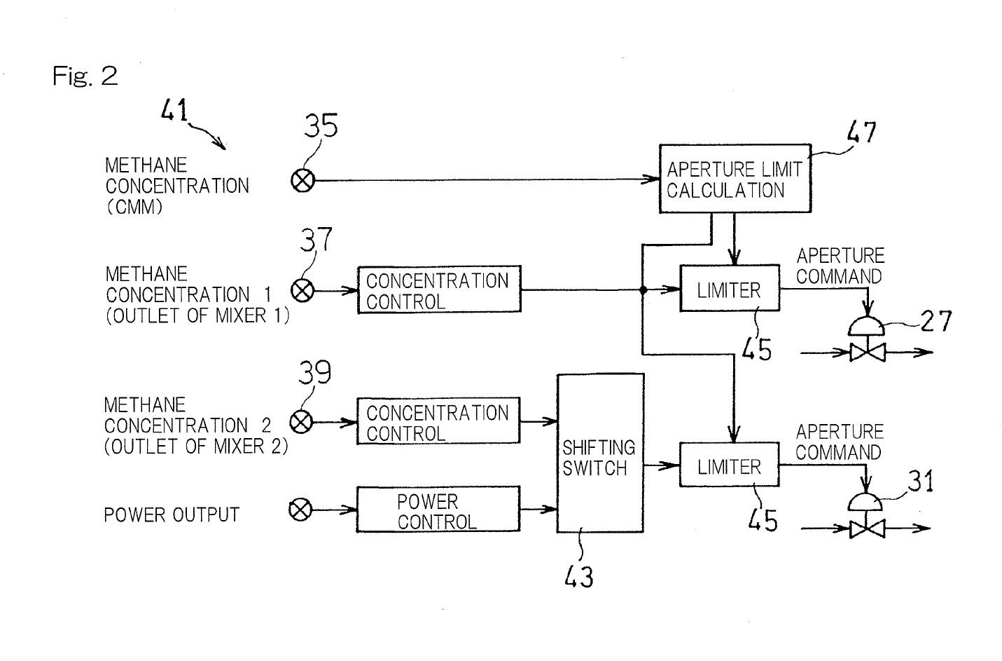

Next, a specific control logic of the controller 41 will be described. As shown in FIG. 2, control to a minimum fuel concentration (e.g., 1%) necessary to drive the load L (to maintain a power generating state in this example) is performed at the first mixer 21 by adjusting an aperture of the first fuel control valve 27 on the basis of the fuel concentration value detected by the second methane concentration meter 37. Meanwhile, control to a fuel concentration (e.g., 2%) necessary to generate rated output is performed at the second mixer 23 by regulating the second fuel control valve 31 on the basis of a generated power value and the fuel concentration value detected by the third methane concentration meter 39. In other words, when the detected fuel concentration value of the third methane concentration meter 39 is sufficiently lower than the fuel concentration necessary to maintain generation of the rated output, control is performed on the basis of the generated power value such that the aperture of the second fuel control valve 31 is increased; and when the detected fuel concentration value reaches a predetermined value close to the fuel concentration necessary to generate the rated output, the control is shifted to concentration control based on the detected fuel concentration value of the third methane concentration meter 39. This control shifting is performed by a shifting switch 43.

The controller 41 further includes, as a regulator for regulating an upper limit of a total flow rate of the CMM to be mixed with the VAM, a limiter circuit 45 which regulates an upper limit value of aperture command with respect to the first and second fuel control valves 27 and 31. The limiter circuit 45 controls the aperture instructions with respect to the first and second fuel control valves 27 and 31 in accordance with a maximum fuel amount which does not cause an explosion within the compressor and is calculated in a limit calculation circuit 47 on the basis of measured values of the CMM fuel concentration, the VAM fuel concentration, and a flow rate of air sucked by the gas turbine. The provision of the limiter circuit 45 allows an explosion within the compressor to be avoided more assuredly even in the case where the CMM fuel concentration is rapidly increased.

In order to avoid delay of control of the fuel concentration which is caused due to delay of the CMM fuel concentration measurement by the first methane concentration meter 35 and delay of operation of the first fuel control valve 27, the first mixer 21 and the second mixer 23 may be arranged so as to be spaced apart from each other by a predetermined distance. For example, the passage distance between the first mixer 21 and the second mixer 23 (the distance along the fuel main supply passage 13) is set so as to be longer than a distance reached by the first stage mixed gas G6 moving in the fuel passage during a delay time of the concentration adjustment by the controller 41, namely, a passage length calculated from a flow rate in the fuel main supply passage 13, the cross-sectional area of the fuel main supply passage 13 and the delay time of the fuel concentration control. The passage distance between the first mixer 21 and the second mixer 23 is, for example, preferably in the range of 2 to 15 m, more preferably in the range of 3 to 10 mm, and further preferably in the range of 4 to 7 m.

Next, a control operation of the lean fuel intake gas turbine GT in FIG. 1 will be described. When the concentration of the fuel from the CMM supply source 15 is increased, the controller 41 reduces the aperture of the second fuel control valve 31 located upstream of the second mixer 23, while the minimum fuel concentration necessary to maintain a power generating state is maintained in the first mixer 21. On the other hand, when the concentration of the fuel from the CMM supply source 15 is decreased, the controller 41 increases the aperture of the second fuel control valve 31 located upstream of the second mixer 23, while the minimum fuel concentration necessary to maintain a power generating state is maintain in the first mixer 21. At that time, even when the CMM fuel concentration is rapidly increased, due to the effect of the limiter circuit 45 shown in FIG. 2, the concentration of the fuel supplied to the gas turbine GT does not increase to a predetermined value or higher, and it is possible to assuredly avoid an explosion within the compressor 1.

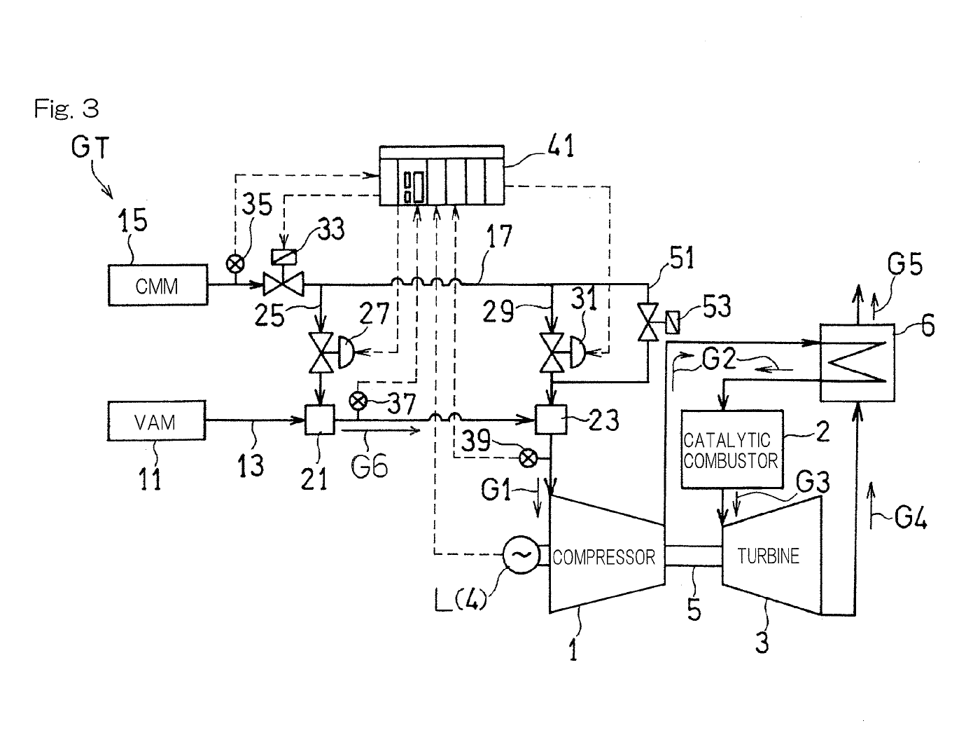

As a modification of the embodiment, as shown in FIG. 3, a bypass passage 51 may be provided so as to extend from the fuel auxiliary supply passage 17 to the second mixer 23, and a bypass fuel cut-off valve 53 may be provided on the bypass passage 51. An opening-closing operation of the bypass fuel cut-off valve 53 is quicker than an opening-closing operation of the second fuel control valve 31. Thus, when the CMM fuel concentration is rapidly increased, it is possible to further effectively avoid an explosion within the compressor 1.

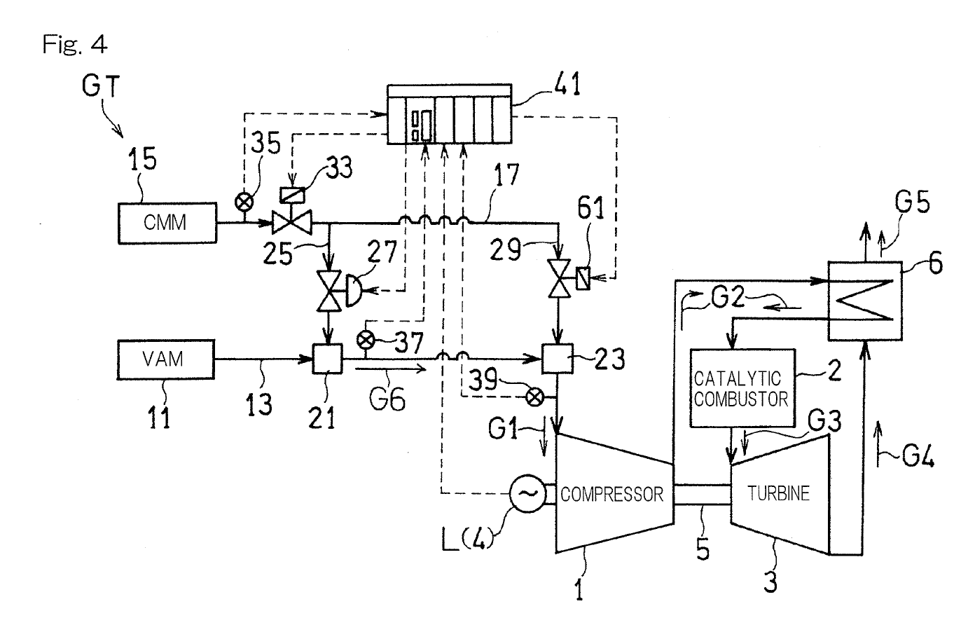

In addition, as a further modification of the embodiment, instead of the second fuel control valve 31 in FIG. 1, a second fuel cut-off valve 61 may be provided as shown in FIG. 4. As an operation of the second fuel cut-off valve 61, after a startup operation is performed and completed at the first fuel control valve 27, an opening operation of the second fuel cut-off valve 61 is performed, and rated power output is obtained. In addition, when the CMM concentration is increased, a closing operation of the second fuel cut-off valve 61 is performed. The provision of the second fuel cut-off valve 61 allows prevention of an explosion within the compressor 1 to be effectively avoided similarly to the bypass fuel cut-off valve 53 shown in FIG. 3, and further allows this avoidance to be achieved with a control circuit simpler than a control valve.

As described above, in the lean fuel intake gas turbine GT according to the embodiment, even when the CMM fuel concentration is varied, it is possible to avoid an explosion within the compressor 1 and a flame off in the catalytic combustor 2 to enable stable operation.

Although the present invention has been described above in connection with the embodiments thereof with reference to the accompanying drawings, numerous additions, changes, or deletions can be made without departing from the gist of the present invention. Accordingly, such additions, changes, or deletions are to be construed as included in the scope of the present invention.

### REFERENCE NUMERALS

1 . . . Compressor
2 . . . Catalytic combustor
3 . . . Turbine
4 . . . Generator
11 . . . VAM supply source
15 . . . CMM supply source
21 . . . First mixer
23 . . . Second mixer
27 . . . First fuel control valve
31 . . . Second fuel control valve
41 . . . Controller
GT . . . Lean fuel intake gas turbine
L . . . Load

What is claimed is:

1. A lean fuel intake gas turbine which uses, as a working gas, a mixed gas having a concentration equal to or lower than a flammability limiting concentration and obtained by mixing two types of fuel gases having different fuel concentrations, the lean fuel intake gas turbine comprising:
a compressor configured to compress the working gas to generate a compressed gas;
a catalytic combustor configured to burn the compressed gas by a catalytic reaction;
a turbine configured to be driven by a combustion gas from the catalytic combustor;
a first mixer configured to mix a second fuel gas having a higher fuel concentration with a first fuel gas having a lower fuel concentration, of the two types of the fuel gases having different fuel concentrations, to generate a first stage mixed gas; and
a second mixer configured to further mix the second fuel gas with the first stage mixed gas to generate a second stage mixed gas which is the working gas.

2. The lean fuel intake gas turbine as claimed in claim 1, further comprising a controller configured to adjust a fuel concentration of the first stage mixed gas generated by the first mixer to a minimum concentration necessary for the gas turbine to drive a load, and to adjust a fuel concentration of the second stage mixed gas generated by the second mixer to a concentration necessary to obtain rated output of the gas turbine.

3. The lean fuel intake gas turbine as claimed in claim 2, wherein a distance of a fuel passage from the first mixer to the second mixer is set so as to be longer than a travel distance to be reached by the first stage mixed gas moving in the fuel passage during a delay time of the concentration adjustment by the controller.

4. The lean fuel intake gas turbine as claimed in claim 2, wherein the controller includes regulator to regulate an upper limit of a total flow rate of the second fuel gas to be mixed with the first fuel gas.
